(19) United States
(12) Patent Application Publication
(10) Pub. No.: US 2008/0232135 A1
(43) Pub. Date: Sep. 25, 2008

(54) Light guide

(75) Inventors: Brian A. Kinder, Woodbury, MN (US); Gary T. Boyd, Woodbury, MN (US); Dale L. Ehnes, Cotati, CA (US); L. Peter Erickson, Minneapolis, MN (US); Charles D. Hoyle, Stillwater, MN (US); Erik E. Jostes, Lake Elmo, MN (US); James W. Laumer, White Bear Lake, MN (US); Jeffrey L. Solomon, Vadnais Heights, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/998,831

(22) Filed: Nov. 30, 2007

Related U.S. Application Data
(63) Continuation-in-part of application No. 11/421,241, filed on May 31, 2006.

(51) Int. Cl. G02B 6/42; F21V 7/04; G02B 6/26

(52) U.S. Cl. 362/615; 385/146

(57) ABSTRACT

A light guide includes an extractor layer and a substrate layer. Each layer has a first major surface and a second major surface. The second major surface of the extractor layer is in contact with the first major surface of the substrate layer, and the first major surface of the extractor layer has a plurality of discrete light extractors capable of extracting light propagating in the light guide such that light is extracted in a predetermined pattern over the first major surface of the extractor layer. In some embodiments, at least one of the extractor layer or substrate layer is flexible.

This application is a continuation-in-part application of U.S. application Ser. No. 11/421,241, filed May 31, 2006, the entire contents of which are incorporated herein by reference.

### FIELD OF THE INVENTION

This invention generally relates to light guides and displays incorporating the light guides. In some embodiments, the light guides are flexible.

### BACKGROUND

Optical displays, such as liquid crystal displays (LCDs), are becoming increasingly commonplace, finding use, for example, in mobile telephones, portable computer devices ranging from hand held personal digital assistants (PDAs) to laptop computers, portable digital music players, LCD desktop computer monitors, and LCD televisions. In addition to becoming more prevalent, LCDs are becoming thinner as the manufacturers of electronic devices incorporating LCDs strive for smaller package sizes.

One type of LCD uses a backlight for illuminating the LCD's display area. The backlight typically includes a light guide in the form of a slab or wedge often of an optically transparent polymeric material produced by, for example, injection molding. In many applications, the backlight includes one or more light sources that couple light into the light guide from one or more edges of the light guide. In a slab waveguide, the coupled light typically travels through the light guide by total internal reflection from the top and bottom surfaces of the light guide until encountering some feature that causes a portion of the light to exit the light guide. These features are often printed dots made of a light scattering material. The printed dots are commonly created by screen printing technologies.

### SUMMARY OF THE INVENTION

Generally, the present disclosure relates to light guides and displays incorporating the light guides.

In one aspect, the present disclosure relates to a light guide including a first layer, or extractor layer, and a second layer, or substrate. Each layer has a first major surface and a second major surface. The second major surface of the extractor layer is in contact with the first major surface of the substrate. The first major surface of the extractor layer has a plurality of discrete light extractors capable of extracting light propagating in the light guide. Light is extracted in a predetermined spatial distribution over the first major surface of the extractor layer.

In some embodiments, at least one of the extractor layer or the substrate layer is flexible. Also, in some embodiments, the predetermined pattern provides substantially uniform illumination over a major surface of the flexible extractor layer.

In another aspect of the invention, a display includes a light source and a light guide. The light guide includes an extractor layer and a substrate layer. Each layer has a first major surface and a second major surface. The second major surface of the extractor layer is in contact with the first major surface of the substrate layer, and the first major surface of the flexible extractor layer has a plurality of discrete light extractors capable of extracting light propagating in the light guide such that light is extracted in a prescribed pattern over substantially the entire first major surface of the flexible extractor layer.

In some embodiments, at least one of the extractor layer or the substrate layer is flexible. Additionally, in some embodiments, the predetermined pattern provides substantially uniform illumination over the entire first major surface of the flexible extractor layer.

In yet another aspect of the invention, a method of manufacturing a light guide includes forming a flexible substrate layer through a substantially continuous process, and forming a flexible light extractor layer on a surface of the flexible substrate layer.

### BRIEF DESCRIPTION OF DRAWINGS

The invention may be more completely understood and appreciated in consideration of the following detailed description of various embodiments of the invention in connection with the accompanying drawings, in which:

FIG. 1 is a schematic side-view of a back light system;

FIG. 2 is a line graph of comparing absorbance spectra of polycarbonate including and not including a light absorbing agent;

FIG. 3A is a schematic top-view of a back light system having discrete light extractors;

FIG. 3B is a schematic three-dimensional view of a backlight system having an alignment tab for alignment with a plate;

FIG. 4 is a schematic three-dimensional view of a backlight system having continuous light extractors that vary with position;

FIG. 5 is a top-view of a backlight system having discrete light extractors that vary with position;

FIG. 6 is a schematic top-view of a backlight system having discrete light extractors that vary with position;

FIG. 7 is a schematic side-view of a display system;

FIGS. 8A-F are schematic top-views of adhesive mechanisms applied to light guides;

FIGS. 9A-D are schematic side-views of multifunctional stacked films;

FIG. 10 is a schematic side-view of back light system;

FIG. 11 is a schematic side-view of a multi-image display including a back light with light extractors;

FIG. 12 is a schematic side-view of a backlight system including wedge-like extractors;

FIG. 13 is a schematic side-view of a backlight system including wedge-like extractors; and

FIG. 14 is a schematic side view of a backlight system utilized to illuminate two objects.

### DETAILED DESCRIPTION

The present disclosure generally applies to back lights that incorporate a light guide for providing a desired illumination pattern in a display system. In some embodiments, the light guides are thin, and can be easily and economically manufactured.

In some embodiments the light guides include multiple layers (two or even three or more layers) for use in a backlight system. In certain embodiments, the light guide is flexible and may be fabricated using a continuous process. Continuous processes suitable for manufacturing of a multilayer light guide of the present disclosure include, for example, continuous cast and cure processes, coextrusion of the multilayer film and molding of the light extraction structures, extrusion of the multilayer light guide and printing of the light extraction structures, extrusion casting and the like. One advantage of the present invention may include reduced light guide thicknesses, which may lead to reduced display thicknesses. Other advantages of the present invention include reduced cost and improved manufacturability.

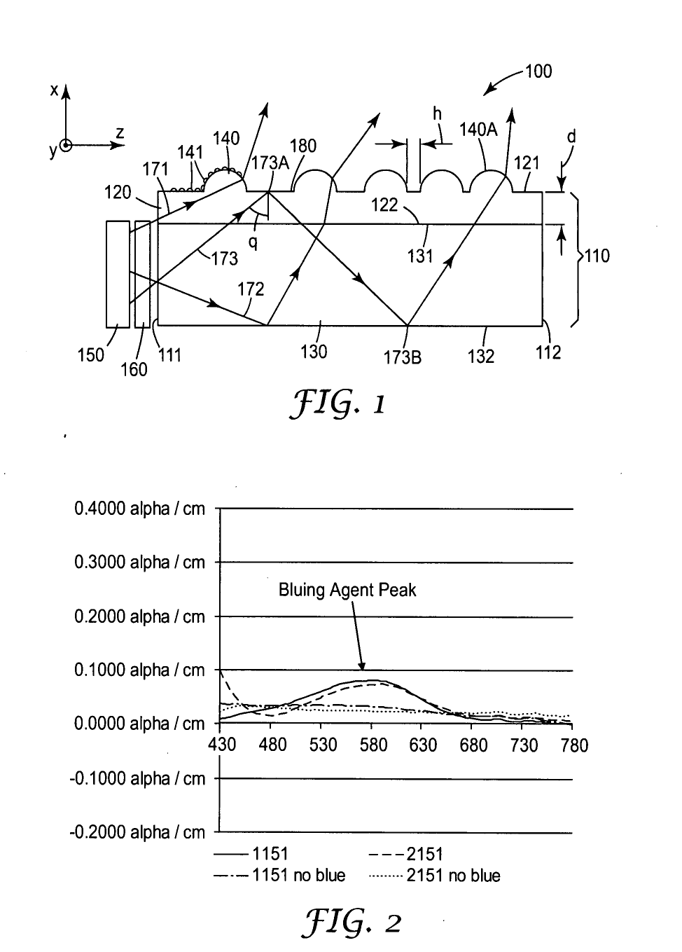

FIG. 1 is a schematic side-view of a backlight system 100. Backlight system 100 includes a light guide 110, a light source 150 placed proximate an edge 111 of light guide 110, and an optical coupler 160 for facilitating the coupling of light from light source 150 to light guide 110. In the exemplary embodiment shown in FIG. 1, optical coupler 160 is distinct from light guide 110. In some applications, optical coupler 160 may be an integral part of light guide 110, for example, by providing an appropriate curvature to edge 111 of light guide 110, and/or by varying the film thickness in an extractor layer in a region close to edge 111.

Light guide 110 includes a first layer, or extractor layer, 120 having a first major surface 121 and a second major surface 122, and a second layer, or substrate layer, 130 having a first major surface 131 and a second major surface 132. In certain preferred embodiments, extractor layer 120 and/or substrate layer 130 are flexible. Second major surface 122 is in contact with first major surface 131. In some embodiments, substantially the entire second major surface 122 is in contact with substantially the entire first major surface 131.

Light from light source 150 propagates in light guide 110 in the general z-direction by reflection from major surfaces 121 and 132, where the reflections can primarily be total internal reflections if desired. For example, light ray 173 undergoes total internal reflection at major surface 121 at point 173A and at major surface 132 at point 173B.

First major surface 121 includes a plurality of discrete light extractors 140 that are capable of extracting light that propagates in the light guide 110. For example, light extractor 140 extracts at least a portion of light ray 171 that propagates in light guide 110 and is incident on light extractor 140. As another example, light extractor 140A extracts at least a fraction of light ray 173 that propagates in light guide 110 and is incident on light extractor 140A. In general, the spacing between neighboring light extractors can be different at different locations on major surface 121. The light extractors can be continuous over the first major surface 121, or discrete individual extractors or discrete areas occupied by light extractors may be separated by areas without extractors, e.g. flat areas, plateaus or land areas. That is, the areal density of light extractors 140 may change over the length or width, or both, of light guide 110. Furthermore, the shape (including the cross-sectional shape), respective heights, and/or respective sizes of the light extractors can be different for different light extractors. Such variation may be useful in controlling the amount of light extracted at different locations on major surface 121. If desired, light extractors 140 can be designed and arranged along first major surface 121 such that light is extracted in a predetermined pattern over a portion or substantially the entire first major surface 121. In some embodiments, light extractors 140 may be designed and arranged along first major surface 121 such that light is extracted substantially uniformly over substantially the entire first major surface 121. Furthermore, a substantially flat plateau area 180 having an average thickness “d” can separate neighboring light extractors. In some embodiments, the average thickness of plateau area 180 is no greater than 20, or 15, or 10, or 5, or 2 microns.

In the exemplary embodiment shown in FIG. 1, light extractors 140 form a plurality of discrete light extractors. In some applications, light extractors 140 may form a continuous profile, such as a sinusoidal profile, that may extend, for example, along the y- and/or z-axes. In some applications, the light extractors 140 may form a non-continuous profile as shown, for example, in FIG. 1.

Light extractors 140 and/or plateau area 180 may include light diffusive and/or diffractive features 141 for scattering a fraction, for example, a small fraction, of light that may be incident on the diffusive features while propagating inside light guide 110. While illustrated in FIG. 1 as protrusions on light extractor 140a and plateau area 180, in other embodiments the features 141 may be depressions in light extractors 140 and/or plateau area 180. Diffusive and/or diffractive features 141 can assist with extracting light from the light guide. For example, the features 141 may increase the efficiency of light extraction by extracting a higher fraction of light incident on light extractors 140. Furthermore, the features 141 can improve uniformity of the intensity of light that propagates inside light guide 110 and is extracted by light extractors 140 by, for example, scattering the light laterally along the y-axis. Additionally, the features 141 may counteract the dispersive effects of the base extraction features, which may also result in a more uniform light intensity, and more uniform color of the extracted light. Diffractive features 141 can enhance light extraction.

The features 141 can be a light diffusive layer disposed, for example by coating, on surface 121. As another example, diffusive and/or diffractive features 141 can be formed while making light extractors 140 by any suitable process, such as microreplication, embossing, or any other method that can be used to simultaneously or sequentially form light extractors 140 and diffusive and/or diffractive features 141.

At least one of layers 120 and 130 may be a bulk diffuser by, for example, including small particles of a guest material dispersed in a host material where the guest and host materials have different indices of refraction. In some preferred embodiments, extractor layer 120 includes a bulk diffuser and substrate 130 does not include a bulk diffuser. Advantageously, when extractor layer 120 includes a diffuse material, the diffuse material may provide a baseline minimum of light extraction along the length of light guide 110. The diffuse material may also minimize the visibility of any defects in light guide 110 by scattering light more uniformly. The guest material may include, for example, nanoparticles that have agglomerated to form a scatter site, glass beads, polymer beads, the materials described in U.S. Published Patent Application No. 2006/0082699 and U.S. Pat. No. 6,417,831, and combinations thereof.

Extractor layer 120 has a first index of refraction n₁ and substrate 130 has a second index of refraction n₂, where n₁ and n₂ can be, for example, indices of refraction in the visible range of the electromagnetic spectrum. For example, n₁ may be greater than, less than, or equal to n₂. In some applications, n₁ is greater than or equal to n₂ for both S-polarized and P-polarized incident light. Additionally, in embodiments where an adhesive adheres extractor layer 120 to substrate 130, n₁ is preferably greater than both n₂ and the index of refraction of the adhesive, and the index of refraction of the adhesive is preferably equal to or greater than n₂.

In some embodiments, at least one of major surfaces 131, 132 may include a matte finish. The matte finish may provide a level of diffusion in the system to scatter light, which may assist in minimizing the visibility of any defects in extractor layer 120 and/or substrate 130. The matte finish may also provide a baseline minimum of light extraction along the length of light guide 110. The choice of whether to finish one or both major surfaces 131, 132 with a matte finish may depend on the difference in refractive indices between extractor layer 120 and substrate 130. For example, when the refractive indices of extractor layer 120 and substrate 130 are sufficiently similar, only second major surface 132 may include a matte finish. One or both of first major surface 131 and the second major surface 132 may include a matte finish. For example, matte finishes on both first major surface 131 and second major surface 132 may be implemented when the refractive indices of extractor layer 120 and substrate 130 are sufficiently dissimilar. A matte surface 131 may also promote adhesion between the extractor layer 120 and the substrate 130.

Additionally, the matte finish on each major surface 131, 132 may be tailored to different roughness levels. For example, in some embodiments, second major surface 132 may include a matte finish that is only rough enough to prevent wet-out to another film (not shown) adjacent second major surface 132. In other embodiments, second major surface 132 may include a matte finish that is sufficiently rough to both prevent wet-out to another film (not shown) adjacent second major surface 132 and to affect light extraction. In some embodiments, at least one of extractor layer 120 and substrate 130 is isotropic in refractive index. In some applications, both layers are isotropic.

Light source 150 may be any suitable type of light source such as a cold cathode fluorescent lamp (CCFL) or a light emitting diode (LED). Furthermore, light source 150 may include a plurality of discrete light sources such as a plurality of discrete LEDs.

In the exemplary embodiment shown in FIG. 1, light source 150 is positioned proximate one edge of light guide 110. In general, one or more light sources may be positioned proximate one or more edges of light guide 110. For example, in FIG. 1, an additional light source may be placed near edge 112 of light guide 110.

Extractor layer 120 and substrate 130 are preferably formed of substantially optically transparent material. In some embodiments, the optically transparent materials may be either UV curable or thermally curable. In other embodiments, the optically transparent materials may be melt processable such as, for example, thermoplastics. Exemplary materials include glass or polymeric materials such as cyclic olefin co-polymers (COC), polyester (e.g., polyethylene naphthalate (PEN), polyethylene terephthalate (PET), and the like), polyacrylate, polymethylmethacrylate (PMMA), polycarbonate (PC), polyimide (PI), polystyrene (PS) or any other suitable polymeric material.

In embodiments where extractor layer 120 and/or substrate 130 include an optical polymer, such as, for example PC, the optical polymer preferably does not include any other agent that absorbs light such as, for example, a bluing agent. As seen in FIG. 2, a bluing agent typically has an absorption peak 200 at about 580 nm, which corresponds to yellow light. Thus, by absorbing a larger amount of yellow light, the bluing agent causes the optical polymer to appear less yellow. While this is desirable in some applications, for many light guide applications it may be disadvantageous. Absorbing yellow light may cause there to be less total available light to extract, which lowers the efficiency of the light guide. Thus, making the light guide from an optical polymer such as PC with no bluing agent may increase the efficiency of the light guide and allow larger and/or longer light guides.

In some embodiments, extractor layer 120 and/or substrate 130 are both flexible and are thin enough to be capable of bending without damage to a radius of curvature down to about 100, or 50, or 30, or 15, or 10, or 5 mm.

In some embodiments, the average thickness of the substrate 130 is at least 5, or 10, or 20, or 40 times the maximum thickness of the extractor layer 120.

In some embodiments, the average thickness of the substrate 130 is no greater than 1000, or 700, or 500, or 400, or 250, or 200 microns.

In some embodiments, the maximum thickness of the extractor layer 120 is no greater than 100, or 50, or 15 microns.

In some embodiments, substrate 130 is self-supporting while extractor layer 120 is not. Here, “self-supporting” refers to a film that can sustain and support its own weight without breaking, tearing, or otherwise being damaged in a manner that would make it unsuitable for its intended use.

Substrate 130 may be in the form of a uniformly thick slab, as shown schematically in FIG. 1, in which case, first and second major surfaces 131 and 132 are substantially parallel. In some applications, however, substrate 130 may be in the form of a wedge or other layer of non-uniform thickness.

The exemplary embodiment of FIG. 1 shows convex lenslets as light extractors 140, meaning that each lenslet forms a bump on surface 121. In general, light extractors 140 can have any shape (e.g., cross-sectional shape or three-dimensional shape) that can result in a desired light extraction. Light extractors 140 may form depressions in surface 121, or may form protrusions from surface 121. Light extractors 140 may include concave structures forming depressions in surface 121, convex structures such as hemispherical convex lenslets, pyramidal structures, prismatic structures, trapezoidal structures, sinusoidal structures, elliptical structures, or any other shape with linear or nonlinear facets or sides that may be suitable in providing, for example, a desired light extraction pattern. The cross-sectional shape of the light extractors 140 may modify the extractive power of the feature or control the angular distribution of the extracted light. The features can be shaped to extract light at a predetermined angle such as, for example, normal to a surface or over a predetermined range of angles.

The cross-sectional shape of the light extractors 140 may also affect wear on light guide 110 or other components of a back light system. As one illustration, forming light extractors 140 as concave depressions may reduce the wear on light extractors 140 and any other component in contact with first major surface 121 of extractor layer 120 by increasing the surface area in contact, when compared to protruding pyramidal light extractors 140, for example.

Additionally, the spacing of the individual light extractors 140 in one or both of the y- and z-axes may be varied to reduce Moiré. Moiré may occur between light guide 110 and any other component of back light system 100, including a liquid crystal display panel, a prism film that is included in the backlight system 100, or between light guide 110 and a reflection of light guide 110 when backlight system 100 includes a reflector layer. For example, irregularly or randomly spaced light extractors 140 may substantially reduce or even eliminate Moiré in backlight system 100. As another example, the spacing may be regular, but selected to minimize or eliminate Moiré.

In other embodiments, light extractors 140 may include structures formed of a material having a different refractive index than the extractor layer 120 or substrate 130. For example, light extractors 140 may include structures formed by rotogravure printing, silk screen printing, dot matrix printing, microreplication, extrusion casting, embossing, thermal molding, lamination and the like. In these embodiments, light extractors 140 may comprise inks, dyes, or any other materials with a desirable refractive index for light extraction, or may comprise bulk diffusive materials.

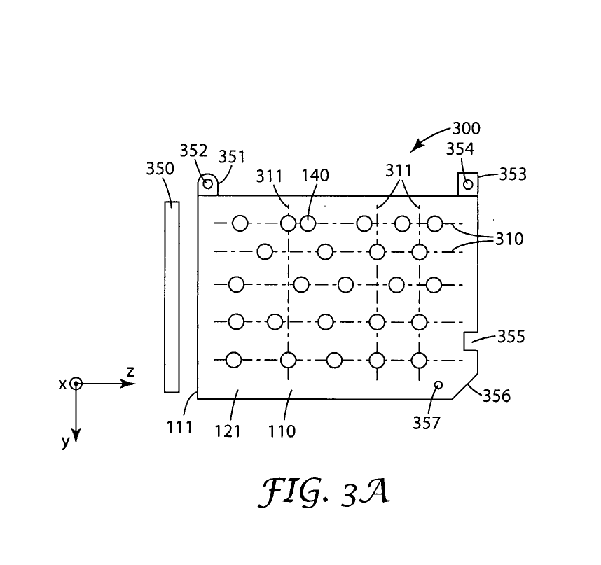

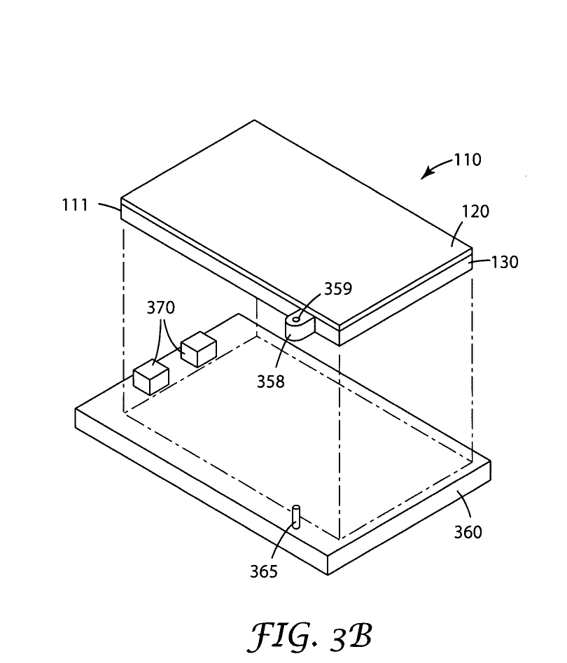

The distribution and density of light extractors 140 can be chosen to provide a predetermined light extraction pattern or illumination and may depend on a number of factors such as the shape of light source 150. For example, FIG. 3A shows a backlight system 300 that includes an extended light source 350, such as a line-light source, placed proximate an entire edge 111 of light guide 110. In this example, the plurality of discrete light extractors 140 are arranged along a plurality of mutually parallel lines, such as parallel lines 374 and parallel lines 375 where each line includes at least two discrete light extractors.

In general, the areal density (number of light extractors 140 per unit area of surface 121), shape, size and height, i.e., the geometric factors, of light extractors 140 can be different at different locations along surface 121 of extractor layer 120 to provide a desired light distribution for the extracted light. The areal density, shape, size and height of light extractors 140 may vary regularly or irregularly. For example, the areal density of light extractors 140 may increase as the distance from light source 350 increases or the size of light extractors 140 may increase as the distance from light source 350 increases, or both.

Light guide 110 may have alignment features for aligning the light guide to other components in a system that incorporates the light guide. For example, light guide 110 may have at least one alignment tab and/or alignment notch and/or alignment aperture for aligning light guide 110 to other layers in a system. For example, light guide 110 in FIG. 3A has a round alignment tab 351 with a corresponding through-aperture 352, a square alignment tab 353 with a corresponding through-aperture 354, a side or edge notch 355 cut into light guide 110 along an edge of the light guide, and a corner notch 356 at a corner of the light guide and an alignment aperture 357 positioned at an interior location of the light guide. In some embodiments, alignment features may also include a tab that fits into a slot in the mounting frame. FIG. 3B shows a schematic three-dimensional view of light guide 110 having an alignment tab 358 with a corresponding aperture 359, where the tab is used to align light guide 110 to, for example, a plate 360 that includes a post 365 capable of fitting into aperture 359. Plate 360 further includes light sources 370 for providing light to light guide 110. Inserting post 365 into aperture 359 can assist in aligning light sources 370 with edge 111 of light guide 110. In some embodiments, in addition the alignment tabs, an adhesive may be used to secure and/or connect the light guide within a backlight unit or the like.

In general, it is desirable to arrange the alignment features in light guide 110 in such a way, for example, asymmetrically, so that there is a unique match between the alignment features and their corresponding features in plate 360. Such an arrangement will reduce or eliminate the possibility of, for example, positioning the light guide with the wrong side of the light guide facing plate 360.

FIG. 1 shows discrete light extractors 140 where adjacent light extractors are separated by flat plateau area 180. In some applications, light extractors 140 may form a continuous pattern across a portion of the entire first major surface 121. In some cases, light extractors 140 may form a continuous pattern across the entire first major surface 121. For example, light extractors 140 may form a sinusoidal pattern across surface 121 extending in either the y-axis, z-axis, or both. In some embodiments, light guide 110 can be manufactured using a largely batch, manufacturing method such as injection molding. In other embodiments, materials may be selected for the light guide 110 to permit the use of substantially continuous processes including extrusion, extrusion casting, co-extrusion, microreplication, embossing, thermal molding, lamination, and the like. For example, forming substrate 130 of a flexible material may allow substrate 130 to be manufactured using continuous processes, such as extrusion. Extractor layer 120 may be formed on the flexible substrate 130 by coextrusion, rotogravure printing, silk screen printing, dot matrix printing, microreplication, and the like. These methods of manufacturing may allow production of light guides 110 that are much thinner than light guides 110 formed by injection molding, as is typically practiced. For example, in some embodiments, the diagonal to thickness ratio may be greater than 90.

Manufacturing light guides 110 in a substantially continuous process may include manufacture of light guides 110 in a continuous roll form. For example, a continuous web of a flexible substrate 130 may be manufactured first, and a flexible extractor layer 120 may be added to the flexible substrate 130 by any of the methods described herein, with minimal spacing between each flexible extractor layer 120. In preferred embodiments, the continuous web of flexible substrate 130 is sufficiently wide to accept at least one flexible extractor layer, and at least 10 feet long. Continuous manufacture of light guides 110 also permits the convenient continuous combination of light guides 110 with other films, as will be described below in further detail. After manufacture in a continuous roll form, individual light guides 110 may be separated by any conventional means.

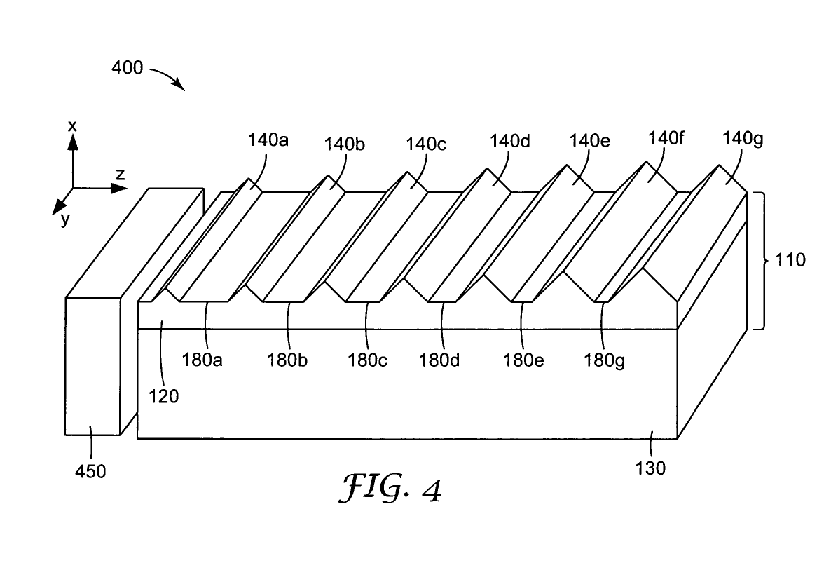

FIG. 4 shows an embodiment of a back light system 400 including a light guide 110 with a plurality of light extractors 140a, 140b, 140c, 140d, 140e, 140f, 140g (collectively “light extractors 140”) that are continuous in the y-direction (perpendicular to the general direction of light propagation). Light extractors 140 are separated by plateau areas 180a, 180b, 180c, 180d, 180e, 180f (collectively “plateau areas 180”).

In another example not shown in FIG. 4, the light extractors 140 need not be continuous, and may constitute discrete structures. Whether discrete or substantially continuous, the size (in the z-direction), height (in the x-direction) and spacing (edge-to-edge or center-to-center as measured in the y-direction or the z-direction) of light extractors may vary widely, and may be varied in a regular or irregular arrangement.

Specifically, in the embodiment shown in FIG. 4, as the distance from light source 450 increases in the z-direction, light extractors 140 are wider, taller, and spaced more closely together. Varying the geometric construction of the light extractors 140 may result in a predetermined light extraction pattern, such as lines, squares, other geometric patterns, or irregular light extraction patterns, or may result in more uniform light distribution over the light guide. Larger structures may extract more light than smaller structures, and more closely spaced extractors may extract more light per unit area than more widely spaced extractors. Thus, as the available amount of light decreases (with increasing distance from light source 450), it may be desirable to provide more light extractors 140 to extract light, which may result in more uniform light distribution over the light guide.

While FIG. 4 illustrates the size, height and spacing of light extractors varying simultaneously, in other embodiments a single geometric factor may be varied while the other geometric factors are not changed. For example, the height of light extractors 140 may increase as the distance from light source 450 increases, while the size and spacing does not change, or the size of light extractors 140 may change while the height and spacing does not change. Any of the geometric factors may change regularly or irregularly over the area of extractor layer 120, and different geometric factors may be changed in different subareas of light guide 110. For example, for half of extractor layer 120, the spacing of light extractors 140 may change while the height and size of light extractors 140 is substantially constant, and in the other half of extractor layer 120 the size of light extractors 140 may change while the density and height of light extractors 140 remains substantially constant.

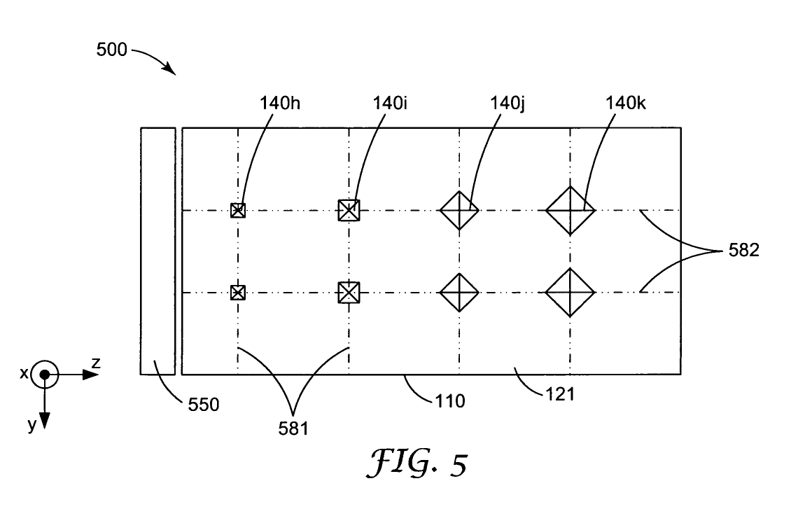

In other embodiments, as illustrated in back light system 500 of FIG. 5, the spacing, or areal density, of light extractors 140h, 140i, 140j, 140k (collectively “light extractors 140”) on light guide 110 is substantially constant, while the size, height and/or orientation of light extractors 140 changes as the distance from light source 550 increases. FIG. 5 shows light extractors 140 having a triangular cross-section and pyramidal shape. In the illustrated embodiment, light extractors 140 are aligned to a rectangular grid 581. In other embodiments, light extractors 140 may be aligned to a hexagonal grid, a triangular grid, or any other desired grid. Additionally, light extractors 140 may be arranged substantially irregularly, with a constant or non-constant areal density of light extractors 140.

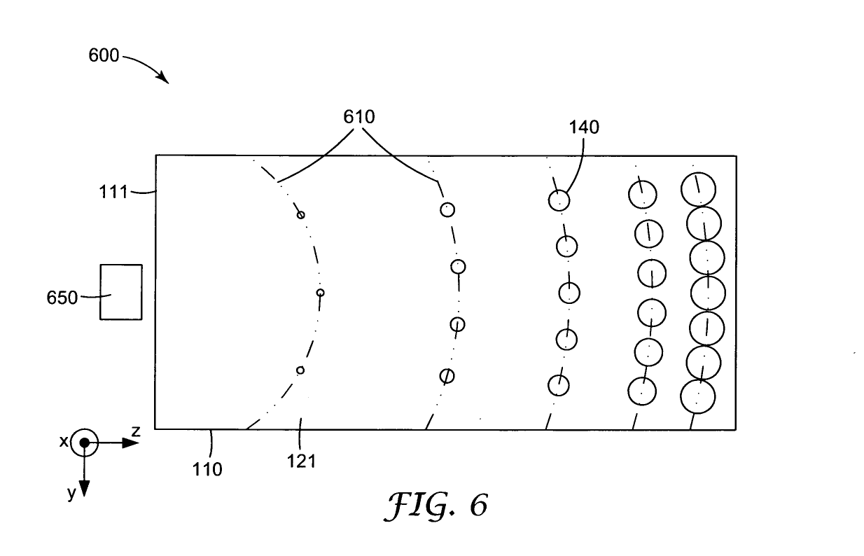

As another example, FIG. 6 shows a backlight system 600 that includes an essentially discrete light source 650, such as, for example, a LED. In this example, the plurality of discrete light extractors 140 are arranged along concentric arcs, such as arcs 610, centered on the light source, where each arc includes at least three discrete light extractors.

The density and size of light extractors 140 can vary across first major surface 121. For example, the density and size can increase with distance along the z-axis. Such an arrangement can, for example, result in light extracted from light guide 110 having uniform irradiance across first major surface 121.

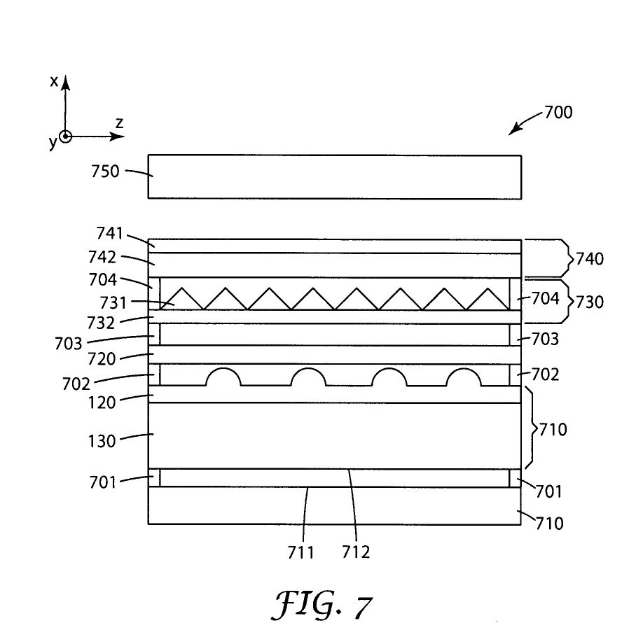

FIG. 7 shows a schematic side-view of a display system 700 in accordance with one embodiment of the invention. Display system 700 includes light guide 110, a diffuser 720, a first light redirecting layer 730, a second light redirecting layer 740, and a display panel 750 such as a liquid crystal panel. Display system 700 further includes a reflector 710 attached to light guide 110 by adhesive 701. Diffuser 720 is attached to light guide 110 and first light redirecting layer 730 with adhesives 702 and 703, respectively. Furthermore, first and second light redirecting layers 730 and 740 are attached by adhesive 704.

Light redirecting layer 730 includes a microstructured layer 731 disposed on a substrate 732. Similarly, light redirecting layer 740 includes a microstructured layer 741 disposed on a substrate 742. Light redirecting layers 730 and 740 can be conventional prismatic light directing layers previously disclosed, for example, in U.S. Pat. Nos. 4,906,070 (Cobb) and 5,056,892 (Cobb). For example, microstructured layer 731 can include linear prisms extended linearly along the y-axis and microstructured layer 741 can include linear prisms extended linearly along the z-axis.

The operation of a conventional light redirecting layer has been previously described, for example, in U.S. Pat. No. 5,056,892 (Cobb). In summary, light rays that strike the structures in microstructured layers 731 and 741 at incident angles larger than the critical angle are totally internally reflected back and recycled by reflector 710. On the other hand, light rays which are incident on the structures at angles less than the critical angle are partly transmitted and partly reflected. An end result is that light redirecting layers 730 and 740 can result in display brightness enhancement by recycling light that is totally internally reflected.

In some embodiments, the patterns of microstructures on any of the microstructured layers in FIG. 7 can be arranged to control Moiré effects. A regular pattern of microstructures may be used that has a pitch selected to cause little or no Moiré, or any number of irregular or partially regular patterns may be used.

FIG. 7 shows adhesives 701-704 placed along opposite edges of display system 700. In general, each adhesive can be placed at one or more locations to provide adequate attachment between adjacent layers. In some embodiments, other attachment mechanisms may be used including, for example, heat lamination, solvent welding, and the like. Regardless of the attachment mechanism used, adjacent layers of display system 700 may be attached at different locations, or with different attachment mechanisms.

Adhesive mechanisms may also be used to attach extractor layer 120 to substrate 130. Any adhesive mechanism utilized to attach adjacent layers of a display system 700, including extractor layer 120 and substrate 130, may include diffusive material. Similar to forming extractor layer 120 of bulk diffuser material, or including matte finishes one or more of surfaces 131, 132, using a diffusive adhesive mechanism may provide a base line minimum of light extraction along the length of light guide 110, and may assist in minimizing the visibility of any defects in light guide 110.

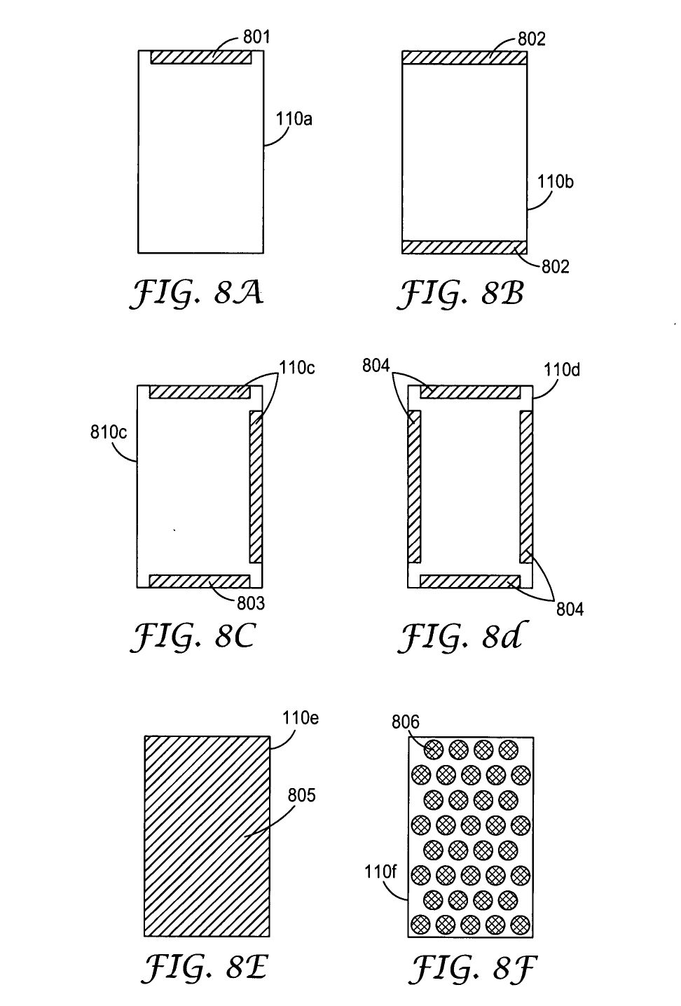

FIGS. 8A-8F show a number of potential configurations for applying adhesive mechanisms 801-806 to light guides 110. For example, FIG. 8A shows an adhesive mechanism 801 along a section of one end of light guide 110a. FIG. 8B, then, illustrates an adhesive mechanism 802 along sections adjacent two edges of light guide 110b. In FIG. 8B, an adhesive mechanism 802 extends substantially the entire length of two edges of light guide 110b. FIG. 8C shows an adhesive mechanism 803 along sections adjacent three edges of light guide 110c. FIG. 8D illustrates an adhesive mechanism 804 along sections adjacent all four edges of light guide 110d. FIGS. 8E and 8F show adhesive mechanisms 805, 806 throughout the area of light guide 110e, 110f, respectively, with adhesive mechanism 805 applied substantially continuously, and adhesive mechanism 806 applied in discrete areas.

In any embodiment, the adhesive mechanisms 801-806 may be applied to a section spanning the entire length of the light guide 110, or to a section spanning a partial length of light guide 110. When adhesive mechanisms 801-806 are utilized to attach multiple layers together, the adhesive mechanism 801-806 configuration need not be the same for each subsequent layer.

In another example, the adhesive pattern can be selected to extract or change the angle of the light.

Additionally, attaching adjacent layers of a display system 700 may increase the structural strength of display system 700. Each of layers 110, 710, 720, 730, 740 is relatively thin, and may deform or warp. Adhering two or more layers 110, 710, 720, 730, 740 to each other may effectively increase the rigidity of the adhered layers relative to the individual layers. Increased rigidity may facilitate display system 700 assembly. Attaching adjacent layers of display system 700 may also reduce deformation or warping due to environmental factors experienced by display system 700, including heat and humidity.

While the exemplary embodiment shown in FIG. 7 includes a number of adhesive layers such as adhesive layers 702 and 703, in some applications, one or more of the adhesive layers in display system 700 may be eliminated. For example, in some applications adhesive layers 702, 703, and 704 may be eliminated in which case the remaining layers may be aligned with respect to each other by other means, such as by aligning the edges of the layers or by including alignment tabs.

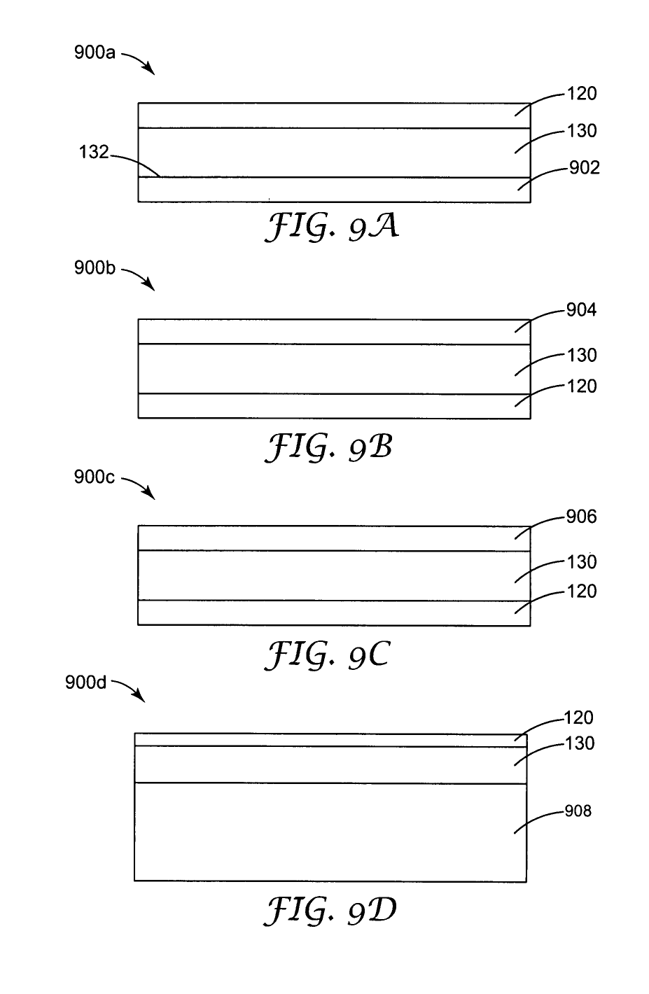

FIGS. 9A-9D illustrate a number of multifunctional stacked films 900a-d (collectively “multifunctional stacked films 900”). Each of the multifunctional stacked films 900 includes a light extractor layer 120, a substrate 130 and at least one other film layer. While many constructions are possible, a number of exemplary embodiments are described in FIGS. 9A-9D.

FIG. 9A shows a multifunctional stacked film 900a including a flexible extractor layer 120, a flexible substrate 130 and a reflector 902 such as, for example, those available from 3M, St. Paul, Minn., under the trade designation Enhanced Specular Reflector. In other embodiments, the layer 902 may include a polarizer such as, for example, those available from 3M under the trade designation DBEF, a diffuser, a secondary extractor layer, anti reflective coatings or layers such as those available from 3M under the trade designation ARM, or any other suitable substrate. Reflector 902 may reflect at least a portion of light exiting surface 132 of substrate 130 back into substrate 130, thus potentially increasing the efficiency of a back light system into which multifunctional stacked film 900a is placed. For example, the reflector 902 can be patterned to be partially transmissive to illuminate a secondary object such as a logo or a secondary LCD (not shown in FIG. 9A).

FIG. 9B illustrates a multifunctional stacked film 900b including extractor layer 120, substrate 130 and reflective polarizer 904. Reflective polarizer 904 may transmit only a certain polarization of light and reflect the rest back into extractor layer 120.

FIG. 9C shows a multifunctional stacked film 900c including extractor layer 120, substrate 130 and diffuser 906. Diffuser 906 may scatter light, which provides benefits including more uniform illumination and minimizing of visual defects, as described above in further detail. Diffuser 906 could be patterned such that it scatters light primarily from a predetermined pattern. For example, the predetermined pattern could be in the shape of a company logo or the like. As another example, the light scattered could also be used to illuminate a detail adjacent to the patterned diffuse area. As yet another example, the scattered light could be used to illuminate details adjacent to the company logo on the back of a notebook computer.

Finally, FIG. 9D shows a multifunctional stacked film 900d including extractor layer 120, substrate 130 and blank substrate 908. Blank substrate 908 may include a rigid material, such as, for example, glass, PC, or the like, which may increase the mechanical strength of multifunctional stacked film 900d.

Extractor layer 120 and substrate 130 may be combined in multifunctional stacked films 900 with any other desired film useful for backlight systems. For example, in other embodiments, extractor layer 120 and substrate 130 may be combined with another prism layer, which may increase the control of the angle of emitted light. In some embodiments, combining extractor layer 120 and substrate 130 with another film layer may also decrease an assembly time of a display system.

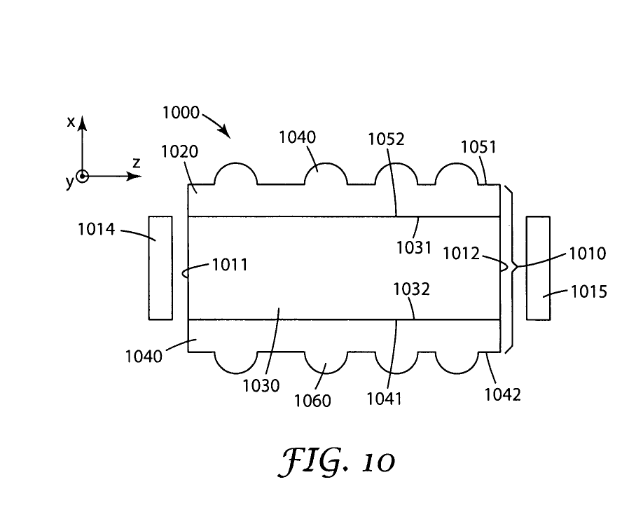

FIG. 10 is a schematic side-view of a backlight system 1000. Backlight system 1000 includes a light guide 1010, a light source 1014 placed proximate an edge 1011 of light guide 1010, and a light source 1015 placed proximate a different edge 1012 of the light guide.

Light guide 1010 includes a first extractor layer 1020 having a first major surface 1051 and a second major surface 1052, a substrate 1030 having a first major surface 1031 and a second major surface 1032, and a functional layer 1040 having a first major surface 1041 and a second major surface 1042. Second major surface 1052 is in contact with first major surface 1031, and first major surface 1041 is in contact with second major surface 1032. In some cases, substantially the entire second major surface 1052 is in contact with substantially the entire first major surface 1031. In some cases, substantially the entire first major surface 1041 is in contact with substantially the entire second major surface 1032.

The first major surface 1051 includes a plurality of discrete light extractors 1043, similar to light extractors 140 of FIG. 1, that are capable of extracting light that propagates in light guide 1010.

In some cases, at least one of first extractor layer 1020, substrate 1030, and functional layer 1040, is isotropic in refractive index. In some cases, all three layers are isotropic.

In some embodiments, each layer 1020, 1030, 1040 is flexible, and the entire light guide 1010 is flexible.

The functional layer 1040 can be applied to the substrate layer 1030 using the same or a different method from that in which the first extractor layer 1020 was applied. Suitable methods of application include, but are not limited to, rotogravure printing, silk screen printing, dot matrix printing, microreplication, extrusion casting, embossing, thermal molding, lamination and the like.

The functional layer 1040 may vary widely depending on the intended application of the light guide 1010. For example, the functional layer 1040 may be at least one of an extractor layer, a diffuser, a reflector, a reflective polarizer, a blank substrate, or an antireflective layer.

In the embodiment shown in FIG. 10, the second major surface 1042 of the functional layer 1040 is an extractor layer, and includes a plurality of discrete light extractors 1060, similar to light extractors 140 of FIG. 1, that are capable of extracting light that propagates in the light guide 1010.

The structures 1060 on the functional layer 1040 in FIG. 10 can vary widely depending on the intended application of the light guide 1010 and the backlight system 1000. For example, the extraction structures on the functional layer can include, but are not limited to inks, dyes, or any other materials with a desirable refractive index, or may include bulk diffusive materials. These materials can also be heat or UV cured. The functional layer 1040 can include an arrangement asymmetric and/or symmetric extractors 1060 that can be the same or different from the extractors 1040 on the first extractor layer 1020. The extractors 1060 can be used, for example, to control the direction and spatial distribution of the light extracted from the light guide 1010. The functional layer 1040 can also be designed to be the primary extraction mechanism for the second light source 1015 (light from light source 1014 can be primarily extracted by the first extractor layer 1020), which is useful in such applications as 3D displays.

In another example, the surface 1042 of the layer 1040 can have a roughened or matte surface to prevent wet-out to an adjacent object. Or, any suitable surface of either or both of the first extraction structure 1020 and/or the functional layer 1040 can optionally include protrusions and/or corresponding depressions that can be used to align and/or retain the components of the light guide 1010.

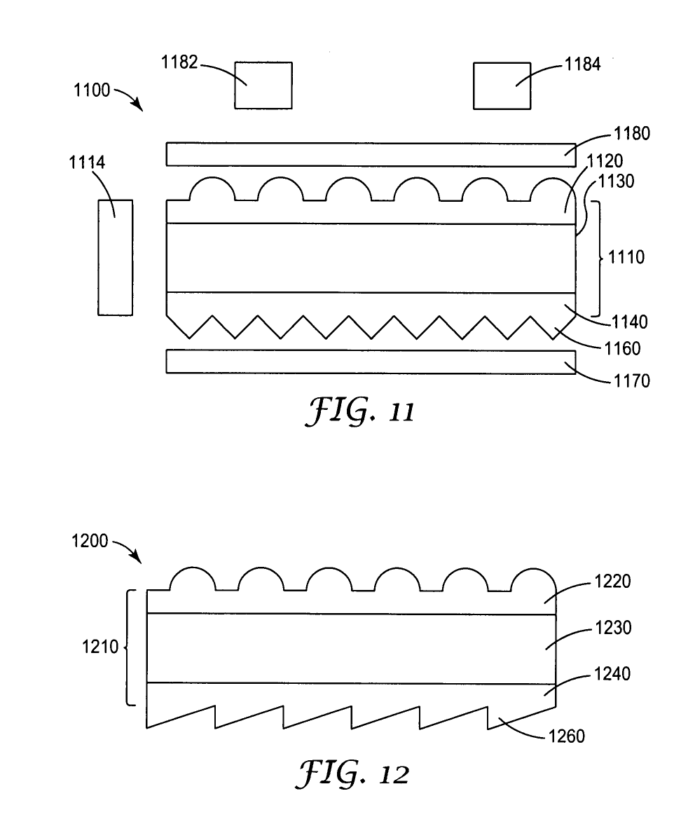

In an embodiment shown in FIG. 11, a multiple image display 1100 includes a light guide 1110 with a first extractor layer 1120 and a second extractor layer 1140 on opposed major surfaces of a substrate 1130. The second extractor layer 1140 includes an arrangement of prismatic extraction structures 1160. In some embodiments, the second extractor layer can be a prismatic polymeric film. In the embodiment shown in FIG. 11, the extractors are oriented generally orthogonal to the direction which light is emitted from a light source 1114. However, orthogonal orientation is not required and, in a preferred embodiment not shown in FIG. 11, the peaks of the prisms are oriented generally parallel to the direction of light emitted by the light source 1114. While generally parallel prisms are preferred, non-parallel prisms can also be useful in controlling light extraction from the light guide 1010. Light rays extracted from the second extractor layer 1140 are reflected from a reflector 1170 and split into two rays by the prismatic structures 1160. The split rays may be viewed by multiple viewers 1182, 1184 at a multiple view display panel 1180.

In another embodiment shown in FIG. 12, a backlight system 1200 includes a light guide 1210 with a substrate 1230 and a first extractor layer 1220. A second extractor layer 1240 includes an arrangement of stepped wedge-like extraction structures 1260. Reflections off the structures 1260 change the propagation angle of light inside the light guide 1210, which can increase extraction efficiency.

As shown in FIG. 13, in a backlight system 1300 with a light guide 1310, the wedge-like extraction structures 1360 in the second extractor layer 1340 can be spaced apart or have flats 1370 or other extraction structures 1372 in areas between them.

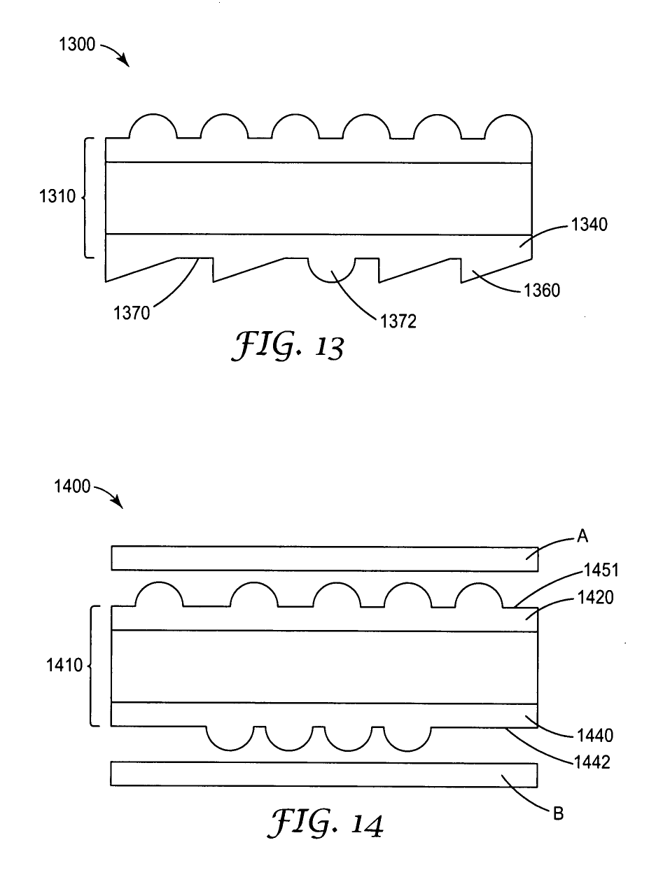

Referring to FIG. 14, in a backlight system 1400 with a light guide 1410, a first extractor layer 1420 and a second extractor layer 1440 can be used in combination to extract light and illuminate two objects A and B located adjacent surfaces 1451 and 1442, respectively. The objects, extractor layers 1420, 1440, and the prescribed illumination pattern for each surface can be the same or different. Examples of objects A,B that can be illuminated with the backlight system 1400 include, but are not limited to, LCD panels and LCD panel/computer notebook covers.

All patents, patent applications, and other publications cited above are incorporated by reference into this document as if reproduced in full. While specific examples of the invention are described in detail above to facilitate explanation of various aspects of the invention, it should be understood that the intention is not to limit the invention to the specifics of the examples. Rather, the intention is to cover all modifications, embodiments, and alternatives falling within the spirit and scope of the invention as defined by the appended claims.

What is claimed is:

1. A light guide comprising an extractor layer and a substrate layer, each layer having a first major surface and a second major surface, the second major surface of the extractor layer being in contact with the first major surface of the substrate layer, the first major surface of the extractor layer having a plurality of discrete light extractors capable of extracting light propagating in the light guide such that light is extracted in a predetermined pattern over the first major surface of the extractor layer.

2. The light guide of claim 1, wherein at least one of the extractor layer or the substrate layer is flexible.

3. The light guide of claim 1, wherein an average thickness of the substrate layer is at least 5 times the maximum thickness of the extractor layer.

4. The light guide of claim 1, wherein an average thickness of the substrate layer is no greater than 700 microns.

5. The light guide of claim 1, wherein the predetermined pattern provides substantially uniform illumination over the entire first major surface of the flexible extractor layer.

6. The light guide of claim 1, wherein the predetermined pattern extracts light from the first surface and/or changes the propagation angle to emerge from the second major surface.

7. The light guide of claim 1, wherein the extractor layer has at least one substantially flat plateau separating the plurality of discrete light extractors, the average thickness of the plateau area being no greater than 10 microns.

8. The light guide of claim 2, wherein at least one of the flexible substrate layer and the flexible extractor layer is capable of being bent to a radius of curvature of 4 mm.

9. The light guide of claim 1, wherein at least one of the first and second major surfaces of the substrate layer comprises a matte finish.

10. The light guide of claim 1, wherein at least one of the extractor layer and the substrate layer comprises at least one of a polycarbonate, an acrylate, an acrylic, a polyolefin, a cyclic olefin, and styrene.

11. The light guide of claim 1, wherein at least one of the extractor layer and the substrate layer is substantially free of a light absorbing additive.

12. The light guide of claim 11, wherein the light absorbing additive comprises a bluing agent.

13. The light guide of claim 1, wherein at least one of the plurality of discrete light extractors comprises at least one of a protrusion and a depression.

14. The light guide of claim 1, wherein each of the plurality of discrete light extractors is truncated.

15. The light guide of claim 1, wherein the light extractors comprise at least a portion of an ellipsoid.

16. The light guide of claim 1, wherein the plurality of discrete light extractors are arranged along concentric arcs centered on the light source, each arc including at least three discrete light extractors.

17. The light guide of claim 1, wherein the plurality of discrete light extractors are arranged along mutually parallel lines, each line including at least two discrete light extractors.

18. The light guide of claim 1, wherein at least one of a density, size, height, orientation, and spacing of the plurality of discrete light extractors varies over the extractor layer.

19. The light guide of claim 16, wherein at least one light extractor extends across the first major surface of the extractor layer.

20. The light guide of claim 1, wherein the extractor layer comprises at least one of a UV cured polymer and a thermally cured polymer.

21. The flexible light guide of claim 1, wherein at least one of the extractor layer and substrate layer is a bulk diffuser.

22. The light guide of claim 1, wherein the extractors are arranged to minimize Moiré effects.

23. The light guide of claim 1, wherein at least a portion of the extractors further comprise a diffractive element.

24. A light guide comprising: a substrate with a first major surface and a second major surface; a first extractor layer with a first major surface on the first major surface of the substrate, wherein a second major surface of the extractor layer comprises a plurality of discrete light extractors capable of extracting light propagating in the light guide such that light is extracted in a predetermined pattern over the first major surface of the extractor layer; and a functional layer on the second major surface of the substrate, wherein the functional layer comprises at least one of an extractor layer, a diffuser, a reflector, a reflective polarizer, a blank substrate, an antireflective layer.

25. The light guide of claim 24, further comprising an adhesive between the second major surface of the substrate and the functional layer.

26. The light guide of claim 25, wherein the adhesive is diffusive.

27. The light guide of claim 24, wherein the functional layer comprises a second extractor layer, and wherein the second extractor layer comprises an arrangement of discrete light extracting structures.

28. The light guide of claim 27, wherein the structures comprise prisms.

29. The light guide of claim 28, wherein the second extractor layer comprises a prismatic polymeric film.

30. The light guide of claim 27, wherein the structures comprise wedges.

31. The light guide of claim 30, wherein the wedges are discontinuous.

32. The light guide of claim 24, further comprising a reflector adjacent the functional layer.

33. The light guide of claim 27, wherein the extractors on at least one of the first and the second extractor layers are arranged to minimize Moiré effects.

34. A display comprising:
a light source; and
a light guide including an extractor layer and a substrate layer, each layer having a first major surface and a second major surface, the second major surface of the extractor layer being in contact with the first major surface of the substrate layer, the first major surface of the extractor layer having a plurality of discrete light extractors capable of extracting light propagating in the light guide such that light is extracted in a predetermined pattern over the first major surface of the extractor layer.

35. The display of claim 34, wherein at least one of the extractor layer or the substrate layer is flexible.

36. The display of claim 34, wherein the predetermined pattern provides substantially uniform illumination over the entire first major surface of the extractor layer.

37. A method of manufacturing a light guide comprising:
forming a flexible substrate layer through a substantially continuous process; and
forming a flexible light extractor layer on a surface of the flexible substrate layer.

38. The method of claim 37, wherein the step of forming a flexible extractor layer comprises forming a flexible extractor layer by at least one of extrusion, coextrusion, rotogravure printing, silk screen printing, dot matrix printing, microreplication, and casting.

39. The method of claim 38, wherein the substrate layer has a length of at least about 10 feet.
